(19) United States
(12) Patent Application Publication
(10) Pub. No.: US 2018/0298639 A1
(43) Pub. Date: Oct. 18, 2018

(54) NO-FAIL SMART LOCK

(71) Applicant: Elliot Rais, New York, NY (US)

(72) Inventor: Elliot Rais, New York, NY (US)

(21) Appl. No.: 15/598,777

(22) Filed: May 18, 2017

Related U.S. Application Data
(60) Provisional application No. 62/485,940, filed on Apr. 15, 2017.

(51) Int. Cl. E05B 47/00; E05B 39/00

(52) U.S. Cl. CPC E05B 47/0001; E05B 2047/0062; E05B 39/00

(57) ABSTRACT

A battery powered smart lock comprising a locking mechanism with an interface element for entry of an unlocking code for controlling the locking mechanism, the interface element being in an electrical circuit with the battery which provides power for the operation of the interface element and unlatching operation of the locking mechanism. The smart lock further comprises a mechanically operated dynamo in an electrical circuit with the interface element wherein the dynamo is externally mechanically operated to provide sufficient electrical energy to power operation of the interface element and unlatching operation of the locking mechanism, in the event that the battery becomes incapable of providing a requisite power operation to unlatch the locking mechanism.

### FIELD OF INVENTION

This invention relates to electronic smart locks and particularly relates to expedients for permitting operation of the lock even when the powering batteries no longer provide requisite energy to operate the lock.

### BACKGROUND OF INVENTION

Electronic smart locks, defined herein as battery controlled locks for latching and unlatching, are sometimes configured to be controlled remotely to perform valuable functions, including the basic function of locking and unlocking a door, assigning or deleting access combination codes, testing the lock's battery level, receiving notifications when an access code opening a door and receiving alerts when the lock battery is low. With such basic functions, no mechanical keys are required. While these are all valuable functions, the basic one of unlocking the door is of utmost importance, with the requirement of certainty that the door lock will function 100% of the time.

Thus, with rental units (a common utilization of electronic locks to provide the security without mechanical key operation and the possibility of keys being inappropriately retained or copied) if a vacation rental guest arrives in the middle of the night, from 1,000 miles away or even from another continent, and the lock fails to open; that is a nightmare of huge proportions. Yet, a tired or failed battery can and will disable a smart lock. Estimates of battery life vary extensively, making periodic maintenance uncertain.

In recognition of this, electronic lock manufacturers have tried to use various expedients including advance warning of battery failure (which is usually unreliable and also problematic particularly if the rental site is remote from the owner for effecting timely maintenance); and configuring the locks with complicating manual mechanical overrides (requiring a separate key or emergency mechanical combination lock). These expedients however, obviate the reasons for using the electronic locks in the first instance.

### SUMMARY OF THE INVENTION

Smart locks are battery powered and batteries can drain unexpectedly, resulting in a lockout. Accordingly, it is an object herein to provide a self-contained 100% reliable hybrid mechanical/electronic emergency backup, for entry in case of lock malfunctions, which will enable unlocking of an electronic lock having a “dead” battery but without external and separate mechanical lock expedients such as keys and spare batteries.

Generally the present invention comprises the inclusion, within or in direct conjunction with a smart electronic lock, of a hand crank generator or dynamo configured to permit the mechanical generation of sufficient electrical energy for a short period of time to enable activation of the electronic lock for opening and entry. It is understood that the term “hand crank” is not limited to a hand operation but encompasses any cranking activation. Hand crank generators or dynamos are commonly found in emergency lighting such as flashlights or for the emergency powering of radios. Typically the cranking of the small generator for about a minute provides up to about one half hour of one watt drain powering. Accordingly, powering of the electronic lock, which requires energy for a small fraction of time used for flashlights and radios, effectively requires minimal effort and cranking time (often as little as two or three seconds) for the backup lock activation.

The mechanical dynamo or electrical power generator is electrically looped into the activation circuit whereby electrical energy generated is directed into the battery control circuit as an effective battery backup. Hand cranked dynamos are generally of three types, with the first involving an energy storage device such as a rechargeable battery (usually a button cell having a lithium anode), or a capacitor which store mechanically generated energy for short term use.

The other two types of dynamos involve immediate electrical generation with either a loaded spring or a continuously operating flywheel. Though the first type is generally included in the present invention (with operational lives greater than those of standard batteries used with smart locks), the latter embodiments have the additional advantage of long term use and effectiveness without the possible degradation of a battery or a capacitor.

The present invention comprises a battery powered smart lock comprising a locking mechanism with an interface element for entry of an unlocking code for controlling the locking mechanism, the interface element is in an electrical circuit with the battery which provides power for the operation of the interface element and unlatching operation of the locking mechanism. The smart lock further comprises a mechanically operated dynamo in an electrical circuit with the interface element wherein the dynamo is configured to be externally mechanically operated to provide sufficient electrical energy to power operation of the interface element and unlatching operation of the locking mechanism, in the event that the battery becomes incapable of providing a requisite power operation to unlatch the locking mechanism.

Common battery powered electronic locks are powered with a single nine volt alkaline battery, two AA or four AAA alkaline batteries all of which provide maximum milliamp capacities for numerous lock activations over a period of time. With the typical batteries and arrangements described, voltages (in series) range from about 3 volts to 9 volts with small milliamp drain. A single or small number of cranks of a typical hand crank generator provides up to about 12 seconds of electrical generation at about one watt drainage which is generally sufficient to permit emergency activation of an electronic lock. It is understood that additional activation time and energy requirements may be provided on an emergency basis with continued “cranking”. The manually powered dynamo generates sufficient electrical energy to analyze an entered key code, and if correct, engage the latch bolt to open a door. This emergency expedient does not require a battery, a key or any tools and is always available for use and is failure proof and lockout proof.

The above objective and other details, features and objectives of the invention will become more evident from the following discussion and drawings in which:

### SHORT DESCRIPTION OF THE DRAWINGS

FIG. 1 is a depiction of a typical smart lock with entry key pad, activation lever and integrated spring loaded generator, with external crank control;

FIG. 2 is similar to the smart lock of FIG. 1, with the crank generator fully contained within the lock housing and wherein the lock control lever is configured to also drive the crank generator;

FIG. 3A is similar to the smart lock of FIG. 2 with external gears shown as being driven by the lock control lever;

FIG. 3B is a side section view of FIG. 3A taken along line 3-3 showing the internal generator elements with a flywheel type of electrical generator;

FIG. 3C is an internal view of the smart lock of FIGS. 3A and 3B;

FIG. 3D is an enlarged view of the generator drive element in FIG. 3C;

FIG. 4A is a smart lock similar to that of FIGS. 1-3D with external electrical terminals configured to engage a completely external hand crank generator;

FIGS. 4B and 4C are front and rear views of the external hand crank generator for use with the smart lock of FIG. 4A;

FIG. 4D is the smart lock of FIG. 4A with the hand crank generator of FIGS. 4B and 4C attached thereto.

### DETAILED DESCRIPTION OF THE INVENTION AND DRAWINGS

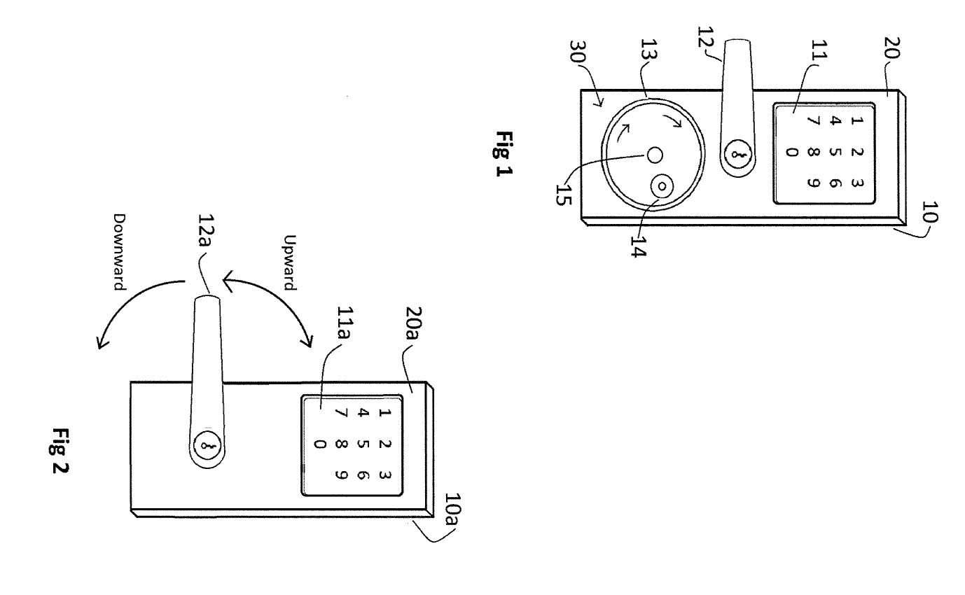

With specific reference to the drawings, in FIG. 1, smart lock 10 has an electronic touchpad or key pad 11 which is internally connected to a latching mechanism (not shown). Entry of a numerical access code closes a circuit and activates the latching mechanism with power from a contained battery or batteries within lock housing 20 to permit the latching mechanism to assume an open position on a door on which the smart lock is placed. The lock latch is disengaged from the door with the lock lever 12 (often provided with an override mechanism utilizing a key, as shown) to enable and complete door opening. Battery failure resulting from insufficient battery power to activate the locking mechanism results in the inability to open the lock and the door.

In the event of the battery power failing, and in the absence of a key for mechanical override of the lock, a person is able to rotate wheel 13 of dynamo 30, with the winding handle 14, to spring load it. Release button 15 is then pressed to release stored spring energy to drive the internal structure of dynamo (not shown but with an internal energy generating structure commonly found in wind up spring loaded emergency lights and/or radios), which in turn provides sufficient electrical energy to the activation circuit of the latching mechanism while the user enters the numerical access code with the key pad 11. If the circuitry determines that it is a correct key code, the latching mechanism is engaged with a latch bolt to the lock lever 12, so that the door can be opened manually. In addition, the electrical energy may also concurrently trigger a notification to an off-site location sent to the proper person advising about the entry and the battery failure.

In the embodiment shown in FIG. 2, the smart lock 10a operates in a manner similar to that of smart lock 10 in FIG. 1 but wherein the dynamo is fully contained within the lock housing 20a. Instead of a fully separate dynamo structure, lock lever 12a is part of the structure by being internally engaged with the dynamo to function in a manner operably similar to the winding handle 14 of the dynamo shown in FIG. 1. In this embodiment, successive movements of lock lever 12a, in, for example, an upward direction serves to turn a flywheel of the dynamo to create electrical energy for the key pad 11a activation with the internal latching mechanism engaging the handle 12a whereby it integrally functions, as in the embodiment of FIG. 1, to open the lock, with movement in a direction opposite to that used for winding (i.e, in a downward direction) activating the spring loaded dynamo with the generation of electricity and caused operable engagement of the lock lever 12a with the internal latching mechanism for engaged opening of the lock with the downward movement of the lock lever 12a.

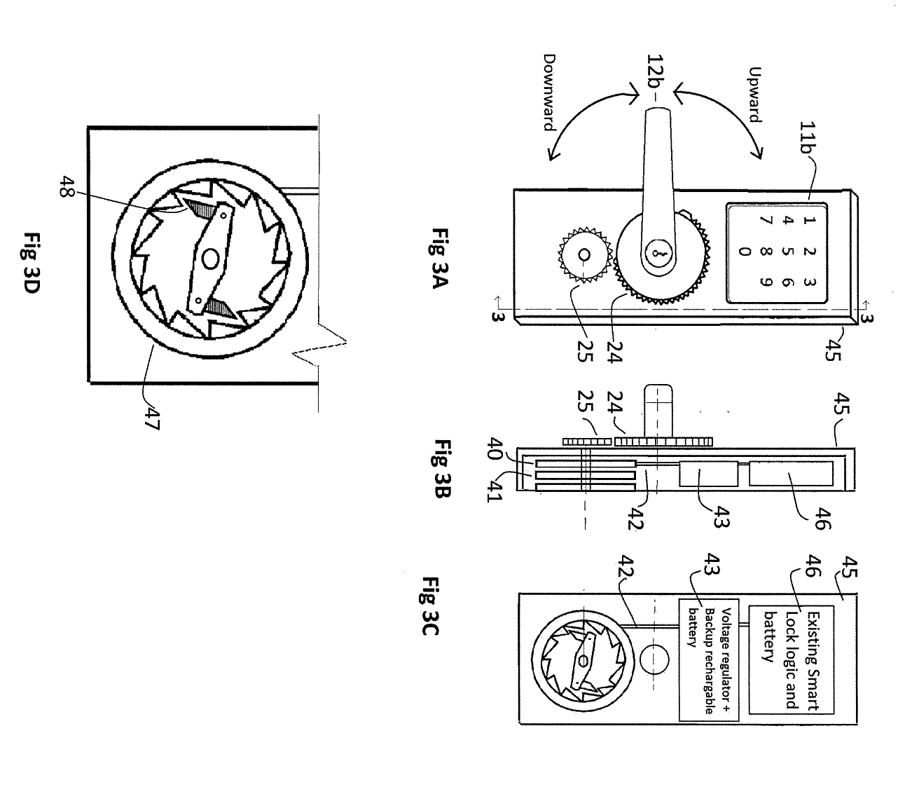

FIGS. 3A-D illustrate engagement of lever 12b with gear 24 to drive gear 25 by means of upward lever movement. Gear 25, shown in FIGS. 3A and 3B drives dynamo 40 with flywheel 41 with electrical generation through circuit 42 to voltage regulator and backup rechargeable battery 43 in housing 45. Existing smart lock logic and battery 46 contained in housing 46 provide an electrically powered interface between a person and the lock mechanism with back-up emergency power from the dynamo 40 with power failure of the rechargeable battery and battery 46. As shown in FIG. 3C and blowup in FIG. 3D bidirectional rotation is converted to uni-directional rotation with cog teeth engagement between drive elements 47 and cog teeth 48.

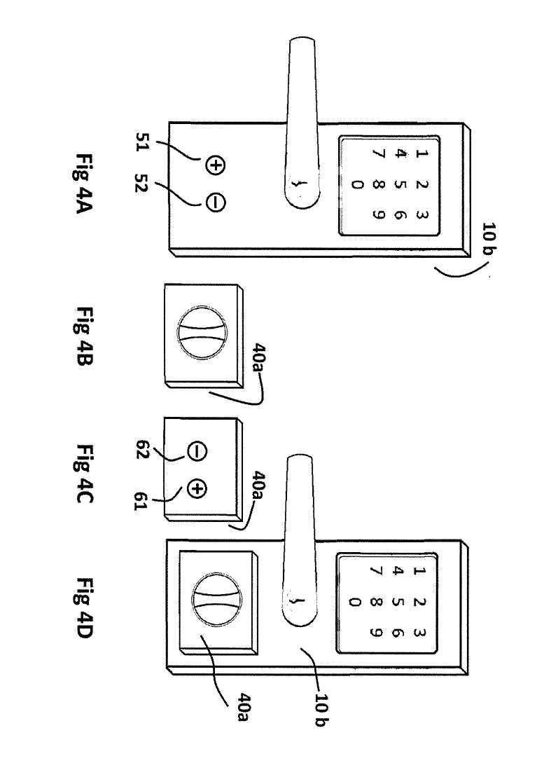

FIG. 4A illustrates and further embodiment with the smart lock 10b having external positive and negative terminal points 51 and 52 which are part of the internal electrical drive circuit of the smart lock 10b. Dynamo module 40a shown in FIGS. 4B and 4C has positive and negative terminals 61 and 62 configured to engage terminal points 51 and 52 respectively when the dynamo module is affixed to the lock 10b as shown in FIG. 4D. Operation of the external dynamo is similar to that of FIG. 1.

It is understood that the above description and illustrative drawings are merely exemplary of the invention, with changes in components, electrical requirements and structure being possible without departing from the scope of the present invention as defined by the following claims.

1. A battery powered smart lock with an emergency back-up mechanically operated dynamo in case of battery failure, the smart lock comprising a locking mechanism with an externally accessible battery powered unlocking-code-entry key pad element configured for external entry of an unlocking code for controlling the locking mechanism, the key pad element being in a direct first electrical circuit with a battery which provides power for operation of the key pad element and unlatching of the locking mechanism, wherein the dynamo is in a direct second electrical circuit, separate from the first electrical circuit and separately directly electrically connected with the key pad element, wherein the dynamo is configured to be externally mechanically operated to directly provide power to the key pad element in the event that the battery becomes incapable of providing the power.

2. The battery powered smart lock of claim 1, wherein the dynamo comprises a spring wound mechanism configured to directly provide the power with winding of the spring and release thereof, which operates the dynamo.

3. The battery powered smart lock of claim 2, further comprising an unlatching handle for the smart lock which is configured to become operationally engaged with the locking mechanism to effect the unlatching of the locking mechanism.

4. The battery powered smart lock of claim 2, wherein the dynamo comprises a rotatable handle which is accessible external to the smart lock and which is configured to be rotated to wind the spring.

5. The battery powered smart lock of claim 3, wherein the unlatching handle is configured to provide winding movement for winding of the spring with movement thereof in one direction and unlatching with movement thereof in another direction, with the effecting of the unlatching of the locking mechanism.

6. The battery powered smart lock of claim 1, wherein the dynamo comprises a rotatable flywheel configured to operate the dynamo to power the key pad element and the unlatching of the locking mechanism with continued rotation of the flywheel.

7. The battery powered smart lock of claim 1, having externally accessible positive and negative terminals of the second electrical circuit and wherein the dynamo comprises a separate operational module configured to be mounted on the smart lock with exposed positive and negative terminals of the dynamo being electrically engaged with the positive and negative terminals of the second electrical circuit.

8. The battery powered smart lock of claim 1, wherein the dynamo is contained within a housing of the smart lock with controls of the dynamo extending through a wall of the housing for external access.

9. The battery powered smart lock of claim 1, wherein the dynamo provides the power to also activate a signaling device in the smart lock and to send notification to an off-site location regarding the unlatching of the locking mechanism.

10.-11. (canceled)
